(19) United States
(12) Patent Application Publication
(10) Pub. No.: US 2019/0223611 A1
(43) Pub. Date: Jul. 25, 2019

(54) Device for Inducing Relaxation and Sleep

(71) Applicants: Xiaowen Yang, Dalian (CN); Jefferson Li, Wellesley, MA (US); Qiyang Li, Cambridge, MA (US); Shengli Li, Wellesley, MA (US)

(72) Inventors: Xiaowen Yang, Dalian (CN); Jefferson Li, Wellesley, MA (US); Qiyang Li, Cambridge, MA (US); Shengli Li, Wellesley, MA (US)

(73) Assignee: Vinnow Health International LLC, Wellesley, MA (US)

(21) Appl. No.: 16/246,427

(22) Filed: Jan. 11, 2019

Related U.S. Application Data
(60) Provisional application No. 62/622,119, filed on Jan. 25, 2018.

(51) Int. Cl. A47C 21/00

(52) U.S. Cl. CPC A47C 21/006; A61H 23/0254; A61H 2201/0146; A47C 21/003

(57) ABSTRACT

The invention is a sleeping or resting device—such as a mattress—which plays music and vibrates. The invention contains multiple vibration units that provide vibrations for a user reclining on top, as well as speakers that provide audio. The vibration units can be controlled through an external device—such as a smartphone—to change its frequency and intensity. The speakers are also able to be controlled through the same external device to change its volume as well as control what is being played. The vibration units and speakers are controlled in groups, in which the vibration is based off the audio of the speakers in that group. Groups are controlled separately. The combination of vibration and audio would aid an individual using the invention to relax and to improve their sleep experience, including bringing the individual to a sleeping state more quickly.

### CROSS-REFERENCE TO RELATED APPLICATIONS

This invention is in reference to and a continuation of the provisional patent No. 62/622,119.

### STATEMENT REGARDING FEDERALLY SPONSORED RESEARCH OR DEVELOPMENT

Not Applicable

### REFERENCE TO A “SEQUENCE LISTING” (IF APPLICABLE)

Not Applicable

### BACKGROUND OF INVENTION

The present invention relates generally to sleep aid devices, such as a sleep aid pad or mattress, more specifically, to an apparatus whereby the user can rest upon to feel vibration, and at will, to hear the audio synchronized with the vibration for the purpose of having better sleep quality. There are other sleep aid devices providing stimulus from vibration or audio. One of the main differences between this current invention and already existing devices is this invention's ability to provide different zones of vibration that can be independently controlled.

### BRIEF SUMMARY OF THE INVENTION

It is an object of the current invention to provide an apparatus that whereby the user can experience a higher quality of sleep and relaxation. This invention provides this effect through the form of a vibrating and sound playing device for users to rest upon. The placement of the vibrational devices allows the vibration to be felt throughout the invention. This array of vibrational devices makes up the vibrating aspect of the invention. The invention contains multiple speakers which are arranged in a manner as to provide sound to the user. Vibration devices and speakers are separated into multiple groups, with the vibration devices and speakers in each group synchronized to each other. The sounds, vibration intensity, and volume outputted by each group in the apparatus are independently controllable through an external device that is capable of a wireless connection. The combination of synchronized vibrations and audio would aid an individual in achieving a more relaxed state of mind and a better sleep quality, such as aiding an individual in falling asleep more quickly.

### BRIEF DESCRIPTION OF DRAWINGS

FIG. 1 depicts the top cross section view of the invention showing potential positions for individual components.

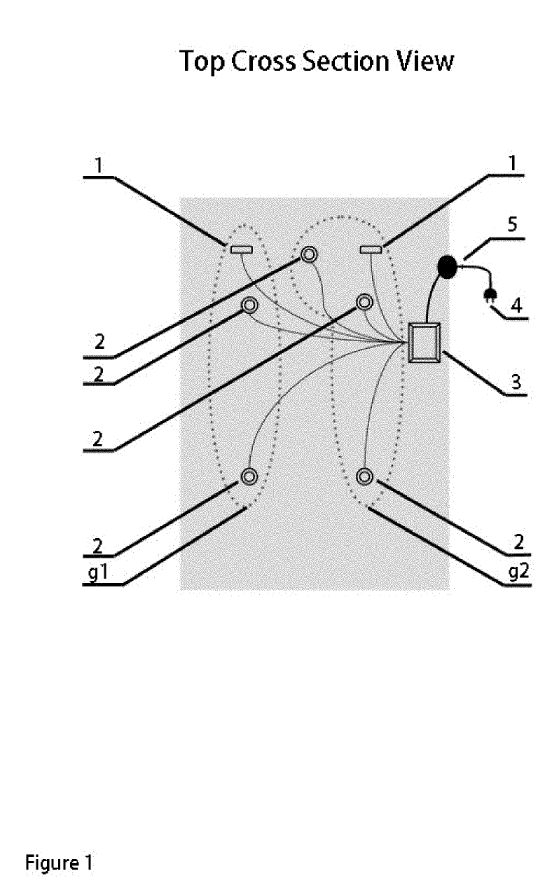

FIG. 2 is an exploded view from the side of the invention, showing the top and bottom portions of the invention and the components between them.

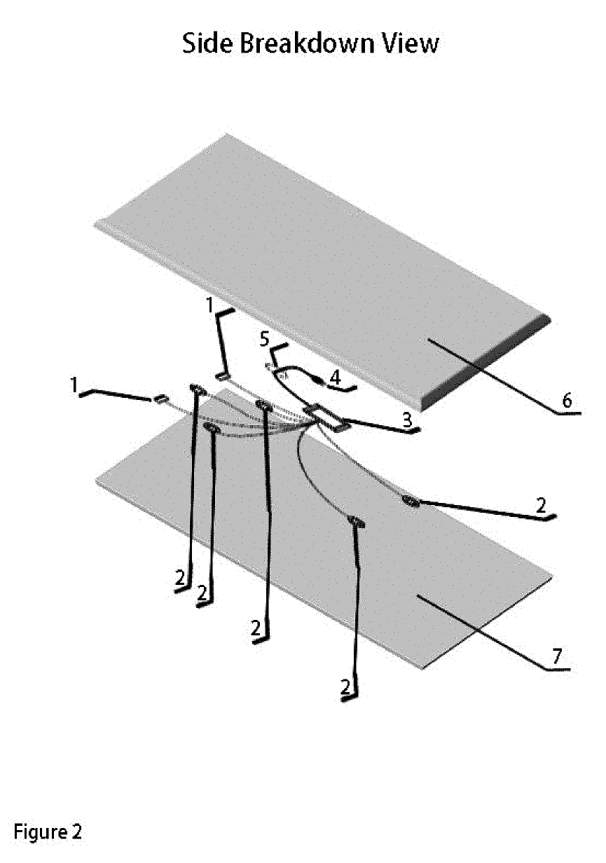

FIG. 3 depicts the use of the device depicted in FIGS. 1 and 2.

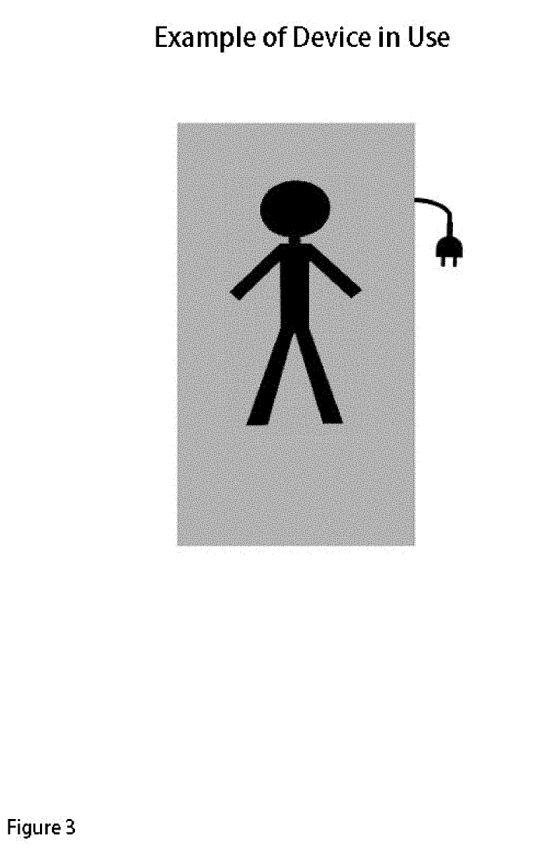

### DETAILED DESCRIPTION OF THE INVENTION

The current invention is a device comprised of an upper [6] and a lower [7] portion, with a space in between the two where the electronic components are secured. The two portions are attached at all other points that do not have electronics in them. On one side of the device, there is a hole [5] in the outer layer that allows wires to feed into the electronic components inside the device.

Multiple vibration units are spaced out around the device. For example, in the diagram, there are five vibration units, all of which are depicted on the diagram as [2]. These vibration units are linked to the central control unit [3] and are secured in between the two portions ([6] and [7]). This central control unit [3] varies and adjusts the intensity of the vibration units [2], determining when and at what level of intensity the vibration units [2] will be activated at depending on the audio source.

Multiple speakers [1] are secured in between the two portions ([6] and [7]). The locations of these speakers are dispersed throughout the mattress. For example, the diagram depicts two speakers which are labelled [1]. The speakers are connected to the central control unit [3]. This central control unit [3] varies the volume of the speakers based on the external device it is wirelessly connected to.

Certain vibration units and speakers are grouped together. Diagram 1 depicts an example for such grouping: the groups are shown in the figure by the dotted line encircling the vibration units [2] and speakers [1], labelled [g1] and [g2]. The central control unit [3] controls each group separately: the vibration of the vibration units [2] and the audio of the speakers [1] in a certain group are synchronized together but are different between the groups.

The central control unit [3] also contains a wireless connector. The central control unit [3] is connected to an exterior device, such as a smartphone, with a wireless connection through its wireless connector. The external device relays information wirelessly to the central control unit [3], which in turn relays the information to the vibration units [2] and speakers [1].

One possible location for the central control unit [3] is shown in the example diagram. In this example, the central control unit [3] is secured inside the device. This central control unit [3] is powered by wire [4], which extends from the inside of the device to the outside, to be attached to a power source. The central control unit [3] can also be placed outside the two portions ([6] and [7]) near the hole [5].

1. The invention is an apparatus comprising of
a. Vibration units
b. Speakers
c. Central Control unit
d. Separate padding portions

2. The apparatus of claim 1 whose vibration unit is defined as a device which gives off vibrations.

3. The apparatus of claim 1 whose central control unit is defined as a device capable of powering and controlling the vibration units and speakers in the apparatus, including a wireless control which allows the apparatus to be controlled wirelessly.

4. The apparatus of claim 1 whose speaker is defined as a device that converts electrical impulses into sound.

5. The apparatus of claim 1 whose vibration units are placed to provide vibration to the entire apparatus' surface.

6. The apparatus of claim 1 where there are regions for at least one person to lay on the apparatus above the vibration units and speakers on the padding portions.

7. The apparatus of claim 1 whose speakers are placed to provide sound to persons laying on the device.

8. The apparatus of claim 1 whose central control unit can vary the volume of the speakers.

9. The apparatus of claim 1 whose central control unit can vary the vibrational intensity of the vibration units.

10. The apparatus of claim 1 whose central control unit has different channels that it can control the vibration units and or speakers with separately.

11. The apparatus of claim 1 whose vibration units are on different channels of the control unit.

12. The apparatus of claim 1 whose speakers are on different channels of the control unit.

13. The apparatus of claim 1 whose vibration units and speakers can be on the same channel.

14. The apparatus of claim 1 where the vibration of the vibration units is synchronized to the audio of the speakers on the same channel.

15. The apparatus of claim 1 whose vibration units, speakers, and central control unit are sandwiched in between the separate padding portions.
